(19) United States
(12) Patent Application Publication
(10) Pub. No.: US 2008/0060496 A1
(43) Pub. Date: Mar. 13, 2008

(54) Transmission device for a band saw

(75) Inventor: Richard Chang, Feng Yuan City (TW)

Correspondence Address: TROXELL LAW OFFICE PLLC, SUITE 1404, 5205 LEESBURG PIKE, FALLS CHURCH, VA, 22041, US

(73) Assignee: King Saw Machinery Ltd.

(21) Appl. No.: 11/518,414

(22) Filed: Sep. 11, 2006

(51) Int. Cl. B23D 53/00

(52) U.S. Cl. 83/788

(57) ABSTRACT

A transmission device for a band saw includes mainly a transmission, which, connected axially with a motor, consists of a driving gear set, a driven gear set, an output gear set and a gear rod. The gear rod is connected with a gearing jaw engaged with the output gear set inside the transmission and having a pushing device able to push the output gear set forward or backward to engage with the driven gear set to rotate in different speeds. And, combined with a driving mechanism, various speeds can therefore be selected for the sawing band to work, depending on the properties of the material to be sawed, upgrading sawing quality and efficiency.

### BACKGROUND OF THE INVENTION

1. Field of the Invention

This invention relates to a band saw, particularly to one provided with a transmission device to give various speeds to a sawing band to work.

2. Description of the Prior Art

As shown in FIG. 1, a conventional band saw 1 is provided with an upper wheel chamber 10 and a lower wheel chamber 20 at its upper and lower portions respectively for installing respectively an upper band wheel 11 and a lower band wheel 12. A conventional transmission 30 set inside the lower wheel chamber 20 is provided with an upper wheel set 31 and a lower wheel set 32. The upper (lower) wheel set 31(32) is provided with a big belt wheel 311(321) and a small belt wheel 312(322), which are linked together coaxially. A belt 33 is employed to mount simultaneously on the big belt wheel 311 and the small belt wheel 322 (or 321 and 312). In addition, the lower wheel set 32 is driven to rotate by a motor 40 via connecting with a motor shaft 41. The upper wheel set 31 shares the same shaft with the lower band wheel 21. Therefore, via matching the belt 33 with two alternative combination of the upper wheel set 31 and the lower wheel set 32, a sawing band 50 of the conventional band saw 1 can work under two models. But, if there are more than two materials with different properties to be sawed, a worktable should be changed, causing an inconvenient work.

### SUMMARY OF THE INVENTION

The objective of this invention is to offer a transmission device for a band saw.

The main characteristic of the invention is a transmission, which, connected axially with a motor, consists of a driving gear set, a driven gear set, an output gear set and a gear rod. The gear rod is connected with a gearing jaw that, engaged with the output gear set inside the transmission, is provided with a pushing device able to push the output gear set forward or backward to engage with the driven gear set to rotate in different speeds. And, combined with a driving mechanism, various speeds can therefore be selected for a sawing band to work, depending on the properties of the material to be sawed, upgrading sawing quality and efficiency.

### BRIEF DESCRIPTION OF DRAWINGS

This invention is better understood by referring to the accompanying drawings, wherein:

FIG. 1 is a side cross-sectional view of a conventional transmission for a band saw;

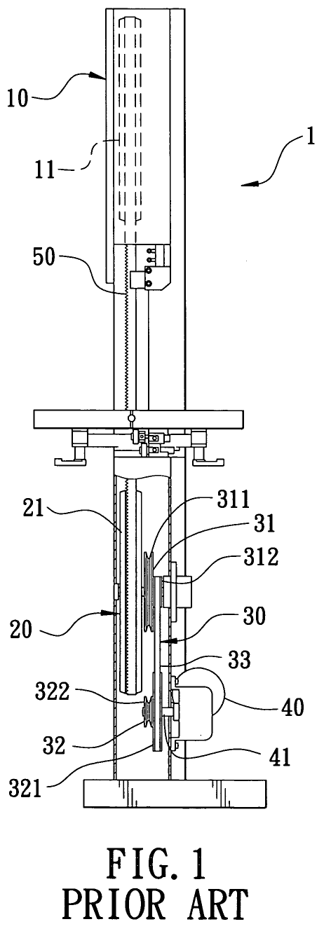

FIG. 2 is a perspective view of a preferred embodiment of a transmission device for a band saw in the present invention;

FIG. 3 is a partial exploded perspective view of the preferred embodiment of a transmission device for a band saw in the present invention;

FIG. 4 is a cross-sectional view of a transmission of the preferred embodiment in the present invention;

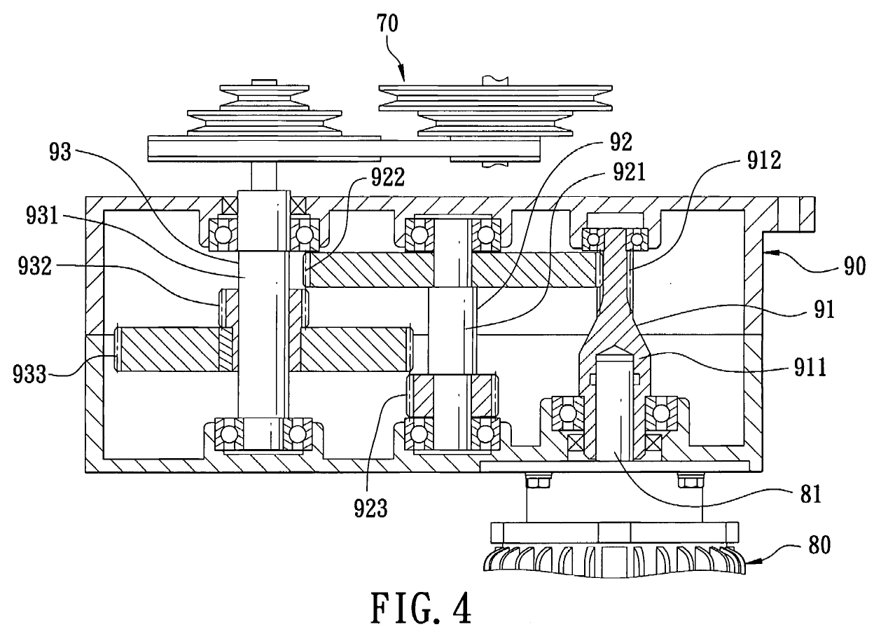

FIG. 5 is a cross-sectional view of a gearing jaw of the preferred embodiment in the present invention, showing it under working condition;

FIG. 6 is a cross-sectional view of the transmission of the preferred embodiment in the present invention, showing it under working in a fast speed;

FIG. 7 is a cross-sectional view of the transmission of the preferred embodiment in the present invention, showing it being working in a slow speed;

FIG. 8 is a side cross-sectional view of a driving mechanism of the preferred embodiment in the present invention; and,

FIG. 9 is a bottom view of the transmission of the preferred embodiment in the present invention.

### DETAILED DESCRIPTION OF THE PREFERRED EMBODIMENT

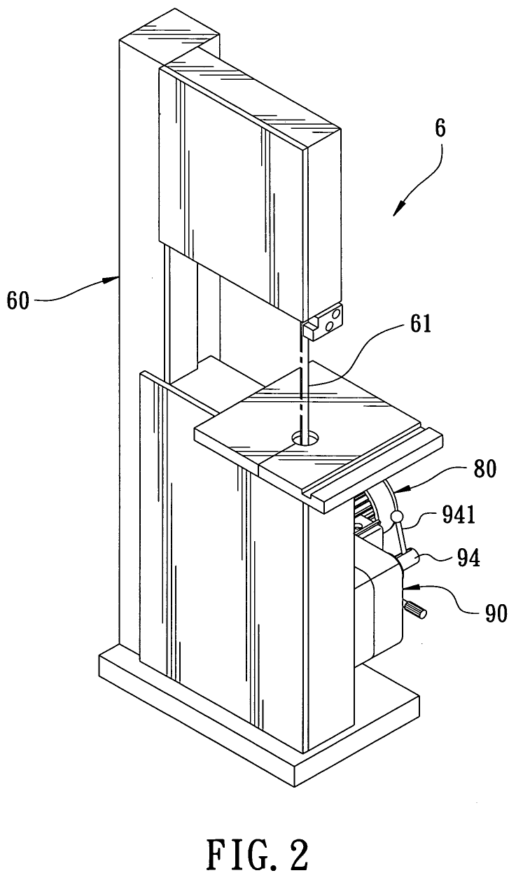

FIGS. 2˜4 show a preferred embodiment of a transmission device for a band saw 6 in the present invention, which consists of a main body 60, a driving mechanism 70, a motor 80 and a transmission 90. The driving mechanism 70 installed in the main body 60 consists of an upper wheel set 71 and a lower wheel set 72. The upper (lower) wheel set 71(72) is provided with a big belt wheel 711(721), a medium belt wheel 712(722) and a small belt wheel 713(723), which are linked together coaxially. A belt 73 is employed to mount simultaneously on the big belt wheel 711 and the small belt wheel 723 (or 721 and 713). In addition, the transmission 90 connected axially with the motor 80 is to drive the belt 73 to rotate in various speeds by altering combination of the upper wheel set 71 and the lower wheel set 72, so that a sawing band 61 of the band saw 6 can move under different speeds.

The motor 80 fixed outside the main body 60 is provided with a motor shaft 81 connected axially with the transmission 90.

The transmission 90 is composed of a driving gear set 91, a driven gear set 92, an output gear set 93 and a gear rod 94.

The driving gear set 91 is provided with a driving shaft 911 connected axially with the motor shaft 81 of the motor 80, and a driving gear 912 fixed on the driving shaft 911.

The driven gear set 92 is provided with a driven shaft 921, a first driven gear 922 and a second driven gear 923, which both are bonded with the driven shaft 921 pivotally. And, the first driven gear 922 is engaged with the driving gear 912 of the driving gear set 91.

The output gear set 93 is provided with an output shaft 931, a small gear 932 and a big gear 933, which are respectively connected with the output shaft 931 pivotally. The output shaft 931 is connected axially with the driving mechanism 70 for driving it.

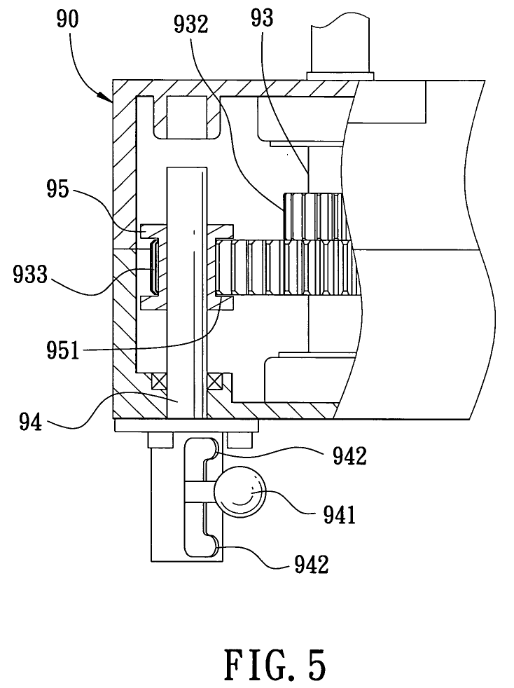

The gear rod 94 is installed partly inside the transmission 90 and partly outside it. As shown in FIG. 5, a knob 941 of the gear rod 94 is fixed outside the transmission 90 and a gearing jaw 95 is set inside the transmission 90. The knob 941 can be moved up or down so as to drive the gear rod 94 to move forwards or backwards, enabling the gearing jaw 95 to engage with the big gear 933 of the output gear set 93 to keep the big gear 933 moving forward or backward via a pushing device 951. By the time, the driven gear set 92 is engaged with the output gear set 93 to start working. In addition, a blocking projection 941 is set at two sides of the knob 941 of the gear rod 94 respectively for restricting the gear rod 94 to drive the gearing jaw 95 to keep the big gear 933 moving forwards or backwards.

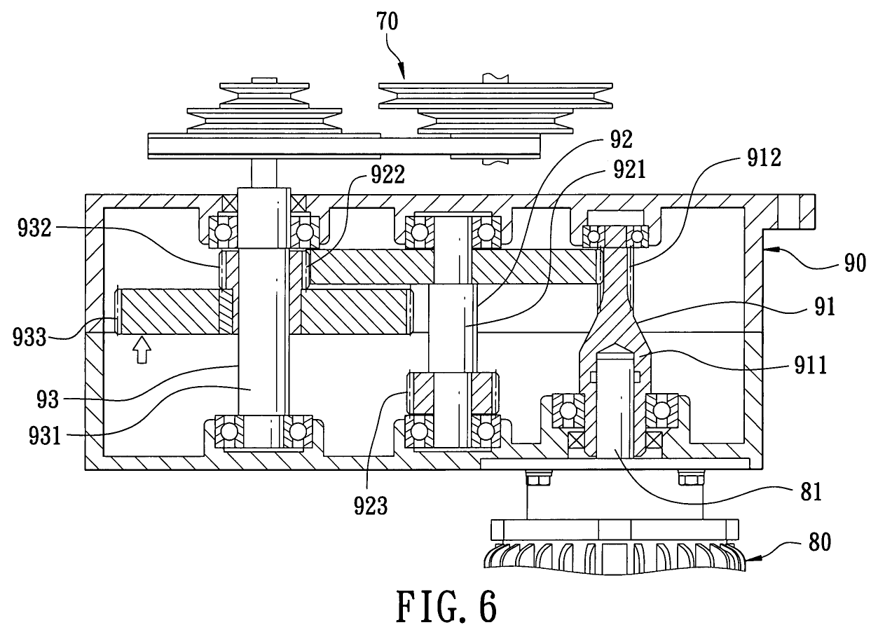

As shown in FIGS. 5 and 6, when the gear rod 94 is moved forward, the gearing jaw 95 is to be driven to push forward the big gear 933, so as to keep the small gear 932 engaged with the first driven gear 922 of the driven gear set 92 to start rotating. As the number of the teeth the first driven gear 922 has are more than those of the small gear 932, the small gear 932 can go more than one round corresponding to one round of the first driven gear 922, so enabling the output shaft 931 to run with a higher RPM and the driving mechanism 70, too.

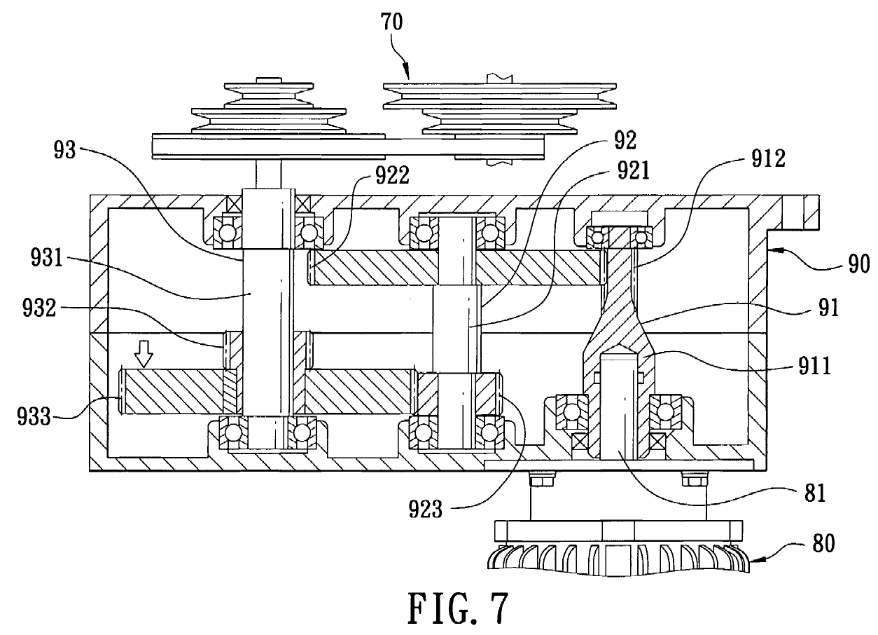

Next, as shown in FIGS. 5 and 7, when the gear rod 94 is moved backward, the gearing jaw 95 is to be driven to push backward the big gear 933, so as to keep the big gear 933 engaged with the second driven gear 923 of the driven gear set 92 to start rotating. As the number of the teeth the second driven gear 923 has are less than those of the big gear 933, the second driven gear 923 has to run more than one round to keep the big gear 933 running for one round, so enabling the output shaft 931 to run with a lower RPM and the driving mechanism 70, too. Therefore, the transmission 90 can be switched to have a high speed or a low one.

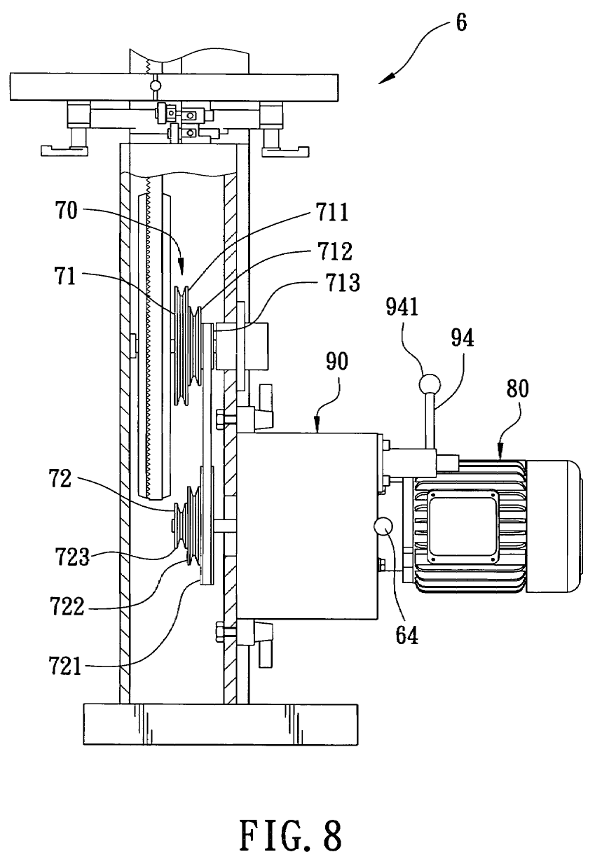

Meanwhile, as shown in FIG. 8, linking combinations between the upper wheel set 71 and the lower wheel set 72 of the driving mechanism 70 are that of the big belt wheel 711 and the small belt wheel 723, that of the medium belt wheel 712 and the medium belt wheel 722, and that of the small belt wheel 713 and the big belt wheel 721. That is, three models with different RPM can be achieved. Combined with two options of the transmission 90, there are six models in the present band saw 6 for a user to select, depending on the property of the material to be sawed, greatly upgrading sawing quality and efficiency.

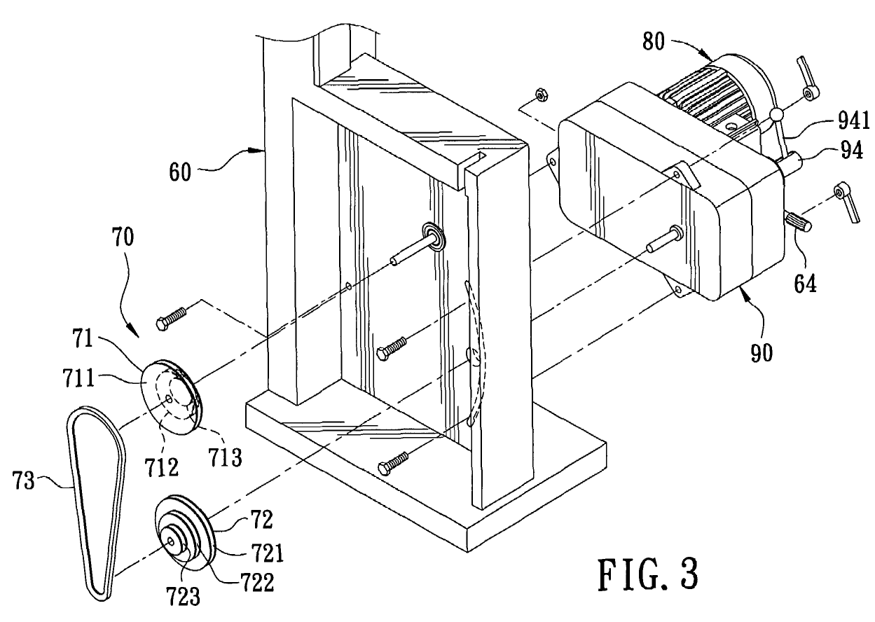

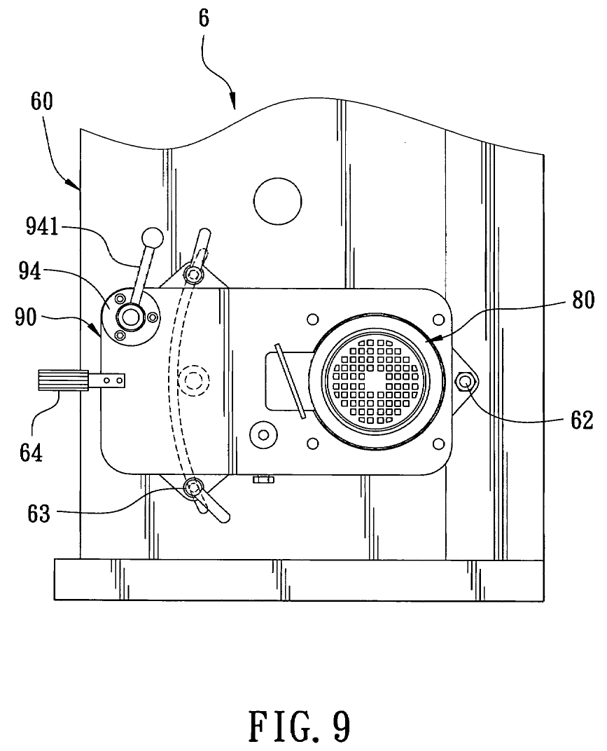

In addition, as shown in FIG. 9, an axial pivot 62 is set on an axial line at one side of the main body 60. Two sides of the main body 60 adjacent to that of the axial pivot 62 are respectively set with a quickly disassemblable locker 63 positioned correspondingly for fixing up the motor 80 swiftly. The axial pivot 62 and the quick-disassembled lockers 63 are formed to become a symmetric track of an arc. The other side of the main body 60 opposite to the axial pivot 62 is installed correspondingly with a switch rod 64, so that the switch rod 64 can move along an arc track corresponding to that of the quickly disassemblable lockers 63. As the distance between the axial pivot 62 and the switch rod 64 is relatively longer, it can save force for a user to pull vertically the switch rod 64. Furthermore, as shown in FIG. 3, the switch rod 64 can drive the lower wheel set 72 to move upward so as to keep the belt 73 loosened from the upper wheel set 71 and the lower wheel set 72 for replacing it. On the contrary, if the lower wheel set 72 is driven by the switch rod 64 to act downward, the belt 73 is to be tightened between the upper wheel set 71 and the lower wheel set 72.

The invention has the following advantages as can be seen from the foresaid description.

1. Via two options of the transmission 90 and three options of the driving mechanism 70, the band saw 6 of the invention can provide as many as six models for sawing materials with different properties, greatly upgrading sawing efficiency and quality.

2. Due to a relative longer distance between the switch rod 64 and the axial pivot 62, a user can save force to pull vertically the switch rod 64, easy to operate the invention.

While the preferred embodiment of the invention has been described above, it will be recognized and understood that various modifications may be made therein and the appended claims are intended to cover all such modifications that may fall within the spirit and scope of the invention.

What is claimed is:

1. A transmission device for a band saw, said band saw having a driving mechanism provided with an upper wheel set and a lower wheel set that are mounted with a preset belt driven by a motor to obtain various models with different speeds for a sawing band to move, said motor installed outside a main body of said band saw and connected axially with a transmission, said transmission comprising:
a driving gear set provided with a driving shaft connected axially with a motor shaft of said motor and a driving gear fixed on said driving shaft;
a driven gear set provided with a driven shaft, a first driven gear and a second driven gear, said first driven gear and said second driven gear respectively bonded with said driven shaft pivotally, said first driven gear engaged with a driving gear of said driving gear set;
an output gear set having an output shaft connected pivotally with a small gear and a big gear, said output shaft connected axially with said driving mechanism; and
a gear rod provided with a knob fixed outside said transmission and having some portion installed inside said transmission connected with a gearing jaw that is engaged with said big gear of said output gear set and provided with a pushing device to push said big gear forward or backward.

2. A transmission device for a band saw as claimed in claim 1, wherein said upper wheel set and said lower wheel set are respectively provided with three belt wheels connected coaxially.

3. A transmission device for a band saw as claimed in claim 1, wherein said main body of said band saw is provided with an axial pivot at its one side and a quickly disassemblable locker respectively at its two sides adjacent to that of said axial pivot and positioned correspondingly, said axial pivot and said quickly disassemblable lockers formed to become a symmetric track of an arc.

4. A transmission device for a band saw as claimed in claim 3, wherein a side of said main body opposite to that of said axial pivot is installed with a switch rod.
